(19) United States
(12) Patent Application Publication
(10) Pub. No.: US 2010/0306236 A1
(43) Pub. Date: Dec. 2, 2010

(54) Data Policy Management System and Method for Managing Data

(75) Inventors: Joseph M. Cychosz, Lafayette, IN (US); Harriet Gladys Coverston, New Brighton, MN (US)

Correspondence Address: BROOKS KUSHMAN P.C. /Oracle America/ SUN / STK, 1000 TOWN CENTER, TWENTY-SECOND FLOOR, SOUTHFIELD, MI, 48075-1238, US

(73) Assignee: SUN MICROSYSTEMS, INC., Santa Clara, CA (US)

(21) Appl. No.: 12/474,663

(22) Filed: May 29, 2009

(51) Int. Cl. G06F 17/30

(52) U.S. Cl. 707/769; 707/609; 707/640; 707/805; 707/822; 707/812

(57) ABSTRACT

A method for managing data includes identifying nodes of an archiving file system executing on one or more computers that have been updated, acquiring time ordered node state change events within the archiving file system, storing the node state change events, and reading the stored node state change events. The method further includes acquiring current information contained within the nodes that has been updated, updating data contained within a database system executing on the one or more computers to reflect the acquired information, querying the database system, and enforcing data policies upon the archiving file system based on the results of the query.

### BACKGROUND

Referring to FIG. 1, a file system 10 may be defined as a collection of files and directories residing on a plurality of random accessible storage devices. Each file or directory within the file system 10 may be represented as a node 12. Files are comprised of a set of allocated blocks of storage 14, 16. The contents of this set of blocks are considered to be the data portion of the file. Directories 18, like files, are comprised of a set of allocated blocks of storage—the contents of which are used to group files and directories as a list. For each item contained within the list comprising the directory, a symbolic name 20 and a pointer 22 to the node of the file is maintained. The file path is the concatenation of the symbolic names resulting from the traversal from the root directory to the directory that instances the file or directory. A file may have a multiplicity of symbolic names and may be instanced in several directories. The file and directory nodes may maintain: a list of allocated blocks of storage assigned to the file or directory, ownership and access information, and a plurality of time stamps tracking events such as creation, modification and access.

An archiving file system may have the additional capability to maintain, for each file or directory, a multiplicity of copies on a plurality of storage devices, either randomly or sequentially accessible, as well as possibly having the capability to maintain and preserve a multiplicity of incarnations. Storage may be stratified into primary storage 24 and secondary storage 26, with the storage blocks 14, 16 residing in the primary storage 24. The data associated with a given file need not be contained in the primary storage 24. It is possible for it to be resident in the secondary storage 26 only. The secondary storage 26 may encompass such technologies as magnetic disk, magnetic tape, non-volatile memories, optical disk and tape, CD-ROM, WORM, etc. Risk of data loss may be managed through the use of the secondary storage 26.

### SUMMARY

A data policy management system includes one or more computers configured to execute an archiving file system, a database system, at least one asynchronous update process, and at least one data policy manager process. The archiving file system is configured to inform the at least one asynchronous update process of nodes that have been updated. The at least one asynchronous update process is configured to acquire current information contained within the nodes that has been updated, and to update data contained within the database system to reflect the acquired information. The at least one data policy manager process is configured to query the database system, and to enforce a set of data policies upon the archiving file system based on results of the query.

A method for managing data includes identifying nodes of an archiving file system executing on one or more computers that have been updated, acquiring time ordered node state change events within the archiving file system, storing the node state change events, and reading the stored node state change events. The method further includes acquiring current information contained within the nodes that has been updated, updating data contained within a database system executing on the one or more computers to reflect the acquired information, querying the database system, and enforcing data policies upon the archiving file system based on the results of the query.

A computer storage medium has information stored thereon for directing one or more computers to (i) identify nodes of an archiving file system that have been updated, (ii) acquire time ordered node state change events within the archiving file system, (iii) store the node state change events, (iv) read the stored node state change events, (v) acquire current information contained within the nodes that has been updated, (vi) update data contained within a database system to reflect the acquired information, (vii) query the database system, and (viii) enforce data policies upon the archiving file system based on the results of the query.

While example embodiments in accordance with the invention are illustrated and disclosed, such disclosure should not be construed to limit the invention. It is anticipated that various modifications and alternative designs may be made without departing from the scope of the invention.

### BRIEF DESCRIPTION OF THE DRAWINGS

FIG. 1 is a schematic diagram of an archiving file system.

FIG. 2 is a block diagram of an embodiment of a data management system.

FIG. 3 is a block diagram on an embodiment of an event entry.

FIG. 4 is a schematic diagram of a portion of the data management system of FIG. 2.

FIG. 5 is another schematic diagram of a portion of the data management system of FIG. 2.

FIG. 6 is yet another schematic diagram of a portion of the data management system of FIG. 2.

### DETAILED DESCRIPTION

A data policy may be a mechanism that provides governance over data that is contained within an archiving file system, either directly through active nodes or indirectly through nodes that had at some temporal moment existed as an active node in the file system. Data policies may control the life span and retention requirements of such data, as well as govern the storage requirements and residency of such data. For example, a data policy may define the minimum number of secondary storage copies that a file must have before it is considered to be safe. Other policies may determine the retention conditions that a file must reside in primary storage. Further policies may define the life span of the data.

The proper operation of an archiving file system may require interrogation of the file system to make decisions regarding the data contained within the given file system. The I/O needed to make these decisions may be unproductive as it detracts from user initiated (productive) I/O including reading, writing or migrating data between primary and secondary storage. A data policy may be used as the instrument of governance to determine a specific data copy's lifespan and storage residency requirements. The management of this data policy may require interrogation of the file system's current state. That is, as files are created, deleted modified, etc., their attributes are changed, and the state of the file system is also changed.

During the governance of data represented by a file system, a given data item may have one of four states (for a given data item associated with a given file, these four states may be a function of file system state for the file, and the data policies that govern the file): (1) The active state—if a file is represented as a node in the current file system, then it along with its current incarnation of data is considered to be active; (2) The dormant state—if a given data incarnation is no longer actively accessible through the current file system (either, for example, by no longer being represented by a node in the file system because the file or directory has been deleted, or due to later incarnation where the node can no longer directly access the data as it resides on secondary storage), then the data is considered to be dormant; (3) The expired state—if a given data incarnation is no longer accessible through the file system and no longer meets the retention policies as expressed by the data policy, then the data is considered to be expired; and, (4) The recycled state—if the data has been exactly copied to a different unit of secondary storage (where a unit of storage may be a plurality of storage devices), then the data is considered to be recycled. This instance of the data theoretically remains available until the unit of storage it resides on is physically over written or destroyed.

Current archiving file systems may have difficulty enforcing a data policy. The task of managing a data policy may require repeated and extensive interrogation of the file and directory nodes, and the directory lists. As mentioned above, computation and I/O incurred by this interrogation may be unproductive and detract from productive computation and I/O related to reading and writing data in the file system. Furthermore, current file systems may have difficulty enforcing data policies at the data level. Policy decisions may be based on the time an archive copy is created, rather than on the creation time or modification time of the data. Furthermore, file system knowledge of the secondary storage of past incarnations of a given data element may be lost. Recovery of such knowledge may require the extensive task of reading all secondary storage associated with the file system.

Advanced backup systems may focus on the backing-up and selective restoral aspects of data management. Other backup systems may focus on the ability to restore a file or set of files should they become destroyed or corrupted. These systems, however, may either have difficulty enacting a data policy, or ignore it all together. While many such systems maintain an inventory (some of which utilize a database) of copies that have been made, this information is not coupled with the file system. The purpose of such inventories is to answer the query “given a file's name, what restorable copies of this file are available?” The backup inventory is not synchronized with the current state of the file system. For example, suppose that a file has been renamed where one of the symbolic names contained within the path of the file has changed. To such a backup system, such a file becomes a completely new entity.

Node information is stored using a database in certain file systems. Such systems rely on immediate synchronous update of the database as the state of the file system changes, i.e., files are created, modified, deleted, symbolic names changed, etc. Without immediate update, these file systems may block subsequent access to the file system.

In certain embodiments, the management of a multiplicity of data policies is separated from an archiving file system. An adjacent database may be employed to mirror (shadow) the state of the file system. The database may be interrogated by a data policy management mechanism, thereby minimizing unproductive I/O upon the file system for the purposes of data governance. A logging mechanism may be used to monitor changes in the state of the file system. An updating mechanism may maintain synchronization between the file system and the adjacent database.

The data policy management may be capable of operating while the adjacent database is inconsistent with the state of the file system. The inconsistency between the adjacent database and the file system may be referred to as a window of inconsistency. The acceptable window of inconsistency may depend on the nature of the query being made on behalf of the data policy manager. The governance of the multiplicity of data policies may be performed within varying windows of inconsistency. The file system, however, may be the final authority. Furthermore, the database may be distributed across a network and need not reside on the system that hosts the file system.

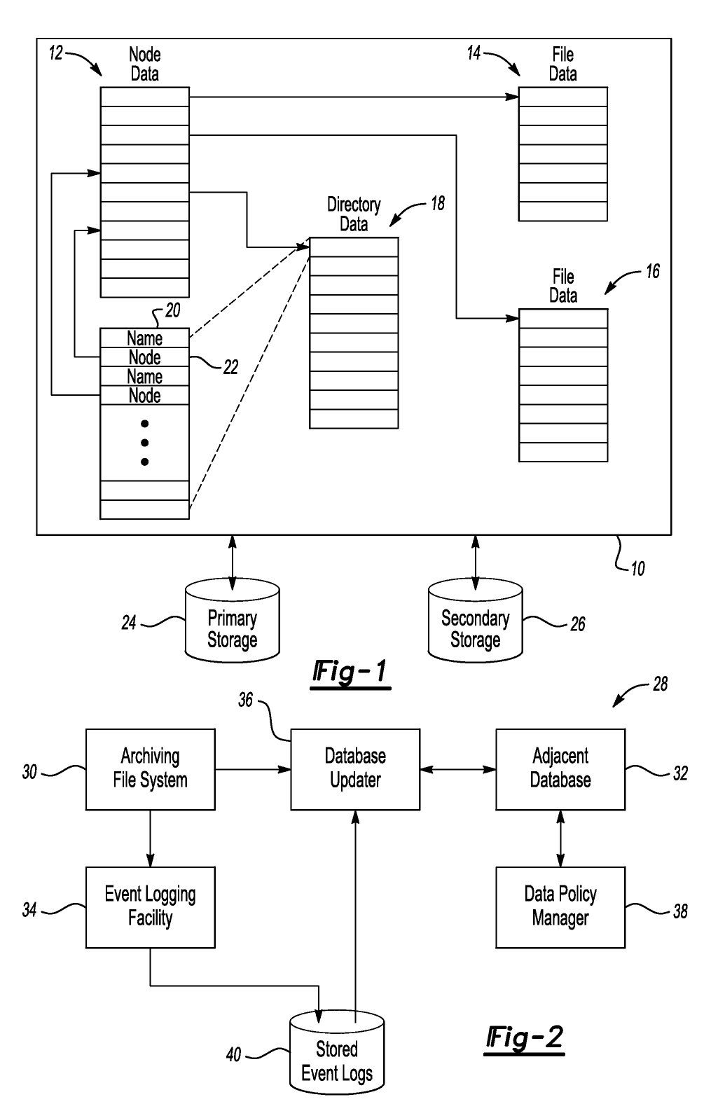

Referring now to FIG. 2, an embodiment of a data management system 28 may include an archiving file system 30, an adjacent database 32 comprised of a database engine and related storage, and a mechanism that reflects changes to the file system 30 in the database 32. With this system 28, the database 32 need only be complete to the extent needed to govern the data policy. The database 32 need not necessarily be concerned with facilitating immediate access to files and directories.

The file system 30 may include a multiplicity of files and directories, and manage storage on a primary storage device and a plurality of secondary storage devices. The file system 30 may also include a host processor(s), and a hierarchy of memories used for the transport of data within the file system 30, and among the primary and secondary storage devices.

The data management system 28 may further include a logger 34 (e.g., a logger process), updater 36 (e.g., updating process), and data policy manager 38 (e.g., a policy manager process). The logger 34 may extract events from the file system 30 in a manner that preserves their order of occurrence. These events may be stored in an event log 40. The updater 36 may update the database 32 to reflect changes made in the file system 30. The data policy manager 38 may interact with the adjacent database 32, and initiate actions to enforce the specified data policies. For some events, the database 32 may already be current with the file system 30 due to the latency of the time the event occurred to the time it is read from the event log 34, and processed by the updater 36, because an earlier event for the node triggered the update where the information was inconsistent.

The adjacent database 32, in some embodiments, may include a database engine such as MySQL, related storage devices that host the data associated with this database, a client application program interface that connects the updater 36 and data policy manager 38 to the database engine, and a set of tables discussed in more detail below. The tables discussed below mirror the relevant information contained within the file system 30. While the tables mirror relevant information in the file system 30, the data associated/accumulated in the database may, over time, contain information beyond that contained in the current state of the file system 30. For example if a file is deleted, the file system 30 may no longer know of the file, whereas the database 32 may contain the history of this file, when created, when deleted, any archive copies residing in secondary storage, etc.

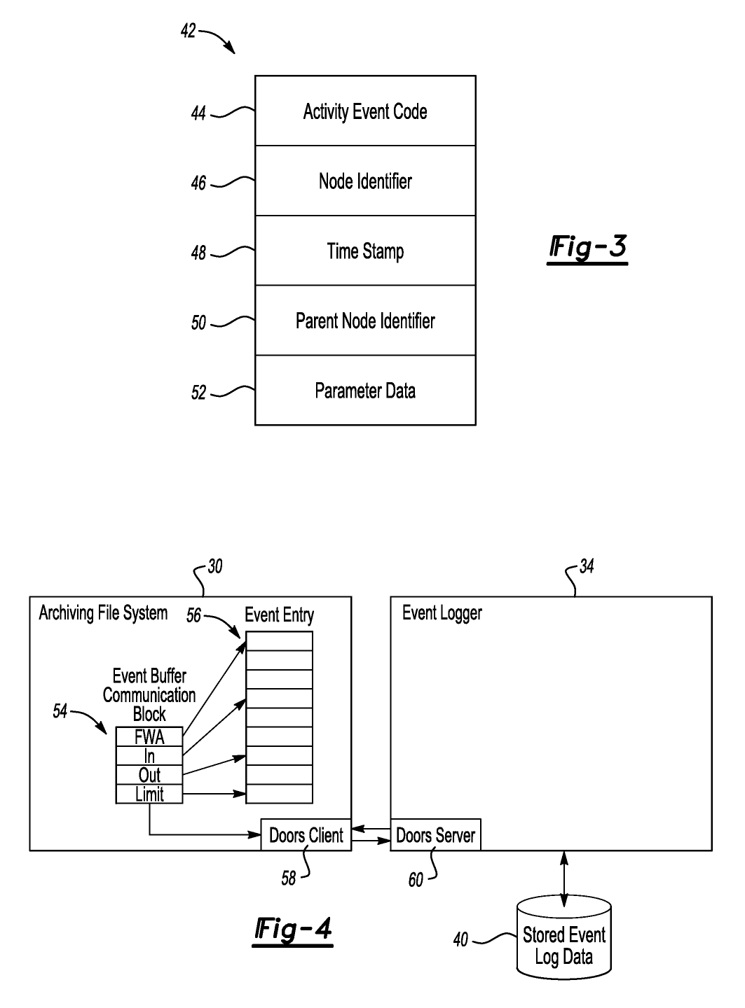

Referring now to FIG. 3, to coordinate changes in state in the file system 30 with the adjacent database 32 (both illustrated in FIG. 2), an ordered buffer may be maintained by the file system 30 that includes activity events. Each event 42, in the embodiment of FIG. 3, may include a code identifying the type of activity 44, a node identifier of the file 46, a time stamp 48 marking the time the event occurred, a node identifier of the parent directory 50 that instanced the file, and an event specific parameter field 52 containing activity specific information. A list of example event types includes file create, file node information change, file rename, file removed, file archive, file modified and closed, file archive copy change, file archive copy stale (file modified), event lost, and file system unmounted. Most of these example events relate to specific changes in a file's state. The file system unmounted event, however, identifies that the file system has been unmounted, and that logging (described below) should terminate.

Referring now to FIG. 4, an embodiment of the logger 34 removes events from the file system 30 and stores them in the event log 40 for later processing in a known manner that allows the updater 36 to apply them to the database 32 (both illustrated in FIG. 2) in the sequence they occurred. Circular buffers 54, 56 (or any other suitable buffering mechanism) may be used. Remote procedure calls 58, 60 may also be used to allow shared access to the circular event buffer 56 and the event buffer control pointers contained in the communication block 54, which define the buffer 56 and its current state. In certain embodiments, Solaris Doors may be used as the remote procedure call mechanism. This allows the file system 30 to notify the logger 34 without having to wait until there is event data in the buffer 56 that can be removed. Furthermore, this allows the logger 34 to remove event entries from the buffer 56 while the file system 30 continues to add new event entries to the buffer 56.

Should the event buffer 56 at any given time have only one remaining entry at the time of the event, a lost event (as mentioned above) may be placed into the buffer 56 and the actual event may be lost. Should the buffer 56 be full at the time, no action may be taken. The event is not recorded and may be considered lost. The time stamp associated with this event marks the start time of lost events. When the buffer 56 has been emptied by the logger 34, the time stamp of the next event marks the time that event logging has resumed. Lost activity may be discovered by the sequential scanning of all nodes for nodes that have a change time after the lost event time stamp and before the time stamp of the following recorded event. The following example node update algorithm may be applied:

1. Get node information from database.
2. If node entry not found, then go to NEW (4).
3. Build lists from database for name and archive.
4. NEW: Read node data from the archiving file system.
5. If node information is not available from 4 and node entry not found in database, then the file is transitory.
6. If node data for this temporal version of the node is not available, DELETE entry as follows:

a. Get name entry for parent directory from database.

b. Search name list (built in 3) for entry that matches name path determined in 6a.

c. Mark entry as deleted.

d. If all entries in name list marked deleted, mark node as deleted.

7. Determine path of parent directory from database.
8. If new node, INSERT node into database, else UPDATE database as follows:

a. If size in node < > size in database then update.

b. If creation time in node < > create time in database then update.

c. If modification time in node < > modification time in database then update.

d. If user id in node < > user id in database then update.

e. If group id in node < > group id in database then update.

f. Update any other fields contained in the node data and tracked in the database.

9. Scan parent directory and build list of all entries that match node identifier. This list is to known as the object list.
10. If name list (built in 3) is empty, then INSERT name into database, go to 15.
11. Mark each entry in name list where the path name does not match the path name (as determined in 7) for this file.
12. For entry in the path list which matches in path, then mark each entry in the name list where the object name matches a name in the object list (built in 9) and remove matching entry from object list.
13. If object list is empty, then INSERT name into database and go to 15. (After execution of 11 and 12, if there is an item in the object list, then the name entry being worked has either been renamed or a new entry created. Furthermore, all marked name list entries are eliminated from consideration since they either did not match in path or a one-for-one match was found between a name in the object list and an object name in the name list.)
14. Use first remaining entry in the object list and UPDATE first unmarked name list entry replacing object name with first remaining entry in object list.
15. For each archive entry identified in the file system node information, do

a. If archive entry not in archive list (built in 3), then INSERT archive entry.

16. For each archive entry UPDATE copy stale status as follows:

a. If modification time in node does not match modification time associated with entry in archive list, then archive entry is considered to be stale.

Special consideration may be made to the algorithm expressed above to accommodate UNIX style symbolic links. The following additional steps may be needed:
1. After 4, build link list from database if file type is symbolic link.

### 2. Insert at 14:

a. Read link value string.

b. If link list empty, then INSERT link into database, else UPDATE database as follows:
i. If link string < > link string in link list entry.
   Directories with a change time after the lost event may need to have their name contents verified with the corresponding name entries in the database.

Referring now to FIG. 5, the updater 36 reads the events that have been stored in the event log 40 by the logger 34 (illustrated in FIG. 2), and updates the adjacent database 32 to reflect the current state of the corresponding nodes. The database 32, in the embodiment of FIG. 5, includes a node table 62, name table 64, archive table 66, and VSN table 68 (see examples below). In other embodiments, however, other and/or different tables may be included.

### Node Table:

| CREATE TABLE IF NOT EXISTS sam_inode ( | | |
|---|---|---|
| ino | INT | UNSIGNED NOT NULL, |
| gen | INT | UNSIGNED NOT NULL, |
| type | TINYINT | UNSIGNED NOT NULL, |
| deleted | TINYINT | UNSIGNED NOT NULL DEFAULT 0, |
| size | BIGINT | UNSIGNED DEFAULT 0, |
| create_time | INT | UNSIGNED DEFAULT 0, |
| modify_time | INT | UNSIGNED DEFAULT 0, |
| delete_time | INT | UNSIGNED DEFAULT 0, |
| uid | INT | UNSIGNED NOT NULL, |
| gid | INT | UNSIGNED NOT NULL, |
| INDEX | (ino), | |
| INDEX | (gen)); | |

Name Table (path table):

| CREATE TABLE IF NOT EXISTS sam_path ( | | |
|---|---|---|
| ino | INT | UNSIGNED NOT NULL, |
| gen | INT | UNSIGNED NOT NULL, |
| type | TINYINT | UNSIGNED NOT NULL, |
| deleted | TINYINT | UNSIGNED NOT NULL |
| | | DEFAULT 0, |
| delete_time | INT | UNSIGNED NOT NULL |
| | | DEFAULT 0, |
| path | VARCHAR(4096), | |
| obj | VARCHAR(256), | |
| initial_path | VARCHAR(4096), | |
| initial_obj | VARCHAR(256), | |
| INDEX | (ino), | |
| INDEX | (gen), | |
| INDEX | (type), | |
| INDEX | (path)); | |

### Archive Table:

| CREATE TABLE IF NOT EXISTS sam_archive ( | | |
|---|---|---|
| ino | INT | UNSIGNED NOT NULL, |
| gen | INT | UNSIGNED NOT NULL, |
| copy | TINYINT | UNSIGNED NOT NULL, |
| seq | TINYINT | UNSIGNED NOT NULL, |
| recycled | TINYINT | UNSIGNED NOT NULL DEFAULT 0, |
| vsn_id | INT | UNSIGNED NOT NULL, |
| size | BIGINT | UNSIGNED DEFAULT 0, |
| modify_time | INT | UNSIGNED DEFAULT 0, |
| create_time | INT | UNSIGNED DEFAULT 0, |
| recycle_time | INT | UNSIGNED DEFAULT 0, |
| stale | TINYINT | UNSIGNED DEFAULT 0, |
| INDEX | (ino), | |
| INDEX | (gen), | |
| INDEX | (vsn_id), | |
| INDEX | (copy)); | |

### VSN Table:

CREATE TABLE IF NOT EXISTS sam_vsns (

| | | |
|---|---|---|
| id | INT | UNSIGNED NOT NULL |
| | | AUTO_INCREMENT, |
| media_type | CHAR(4) | NOT NULL, |
| vsn | CHAR(32) | NOT NULL, |
| recycled | TINYINT | UNSIGNED NOT NULL DEFAULT 0, |
| files_active | INT | UNSIGNED DEFAULT 0, |
| files_dormant | INT | UNSIGNED DEFAULT 0, |
| files_expired | INT | UNSIGNED DEFAULT 0, |
| files_recycle | INT | UNSIGNED DEFAULT 0, |
| size_active | BIGINT | UNSIGNED DEFAULT 0, |
| size_dormant | BIGINT | UNSIGNED DEFAULT 0, |
| size_expired | BIGINT | UNSIGNED DEFAULT 0, |
| size_recycled | BIGINT | UNSIGNED DEFAULT 0, |
| expire_time | INT | UNSIGNED DEFAULT 0, |
| destroy_time | INT | UNSIGNED DEFAULT 0, |
| copy | TINYINT | UNSIGNED DEFAULT 0, |
| uid | INT | UNSIGNED DEFAULT 0, |
| gid | INT | UNSIGNED DEFAULT 0, |

PRIMARY KEY (id),

| | |
|---|---|
| INDEX | (media_type), |
| INDEX | (vsn)); |

Each node in the file system 30 may be identified with a unique number. Certain archiving file systems 30, such as Sun Microsystems' SAM-QFS, uniquely identify each node and each temporal instance or generation of each node. In certain embodiments described herein, each update interrogates node information 70 contained within the file system 30, and a directory that instances a node 72. The file system 30, in the embodiment of FIG. 5, is considered to be the primary and authoritative source.

A rename event occurs when the symbolic name has changed or the file has been moved from one directory to another. In the later case, the parent nodes of the origin directory and destination directory must be reported in the event buffer 56 illustrated in FIG. 4. In certain embodiments, two events are stored with one entry for the directory of origin, and a second identifies the destination directory. During update processing, as events are processed, the rename event identifying the directory of origin may be cached, saving it for when the later event that identifies the destination directory is encountered. It is at this point the rename event may be processed as outlined below:

1. Read node information from the file system.
2. If node information not available, then file has been deleted and the rename is lost, exit.
3. Build name list from database.
4. Determine path of source and target parent directories from database.
5. Scan source and target parent directories and build object lists of all entries that match node identifier.
6. Scan name list to eliminate entries from the name list and corresponding object lists based on the following conditions:

a. If the path matches the target path and the object name is found in the target object list (built in 5), then eliminate name list entry and entry in target object list.

b. If the path matches the source path and the object name is found in the source object list (built in 5), then eliminate name list entry and entry in source object list.

c. If the path does not match the target path or the source path, then eliminate name list entry. (The remaining entry in the name list should be the entry that is being renamed. The target object list should have at least one entry remaining, and in most cases the source object list should be empty. It is possible that subsequent file system operations may have created additional files linked to this node.)

7. If the node is a directory, then update database as follows:

a. For each name entry in database in which the path leading matches the source name as determined from the remaining name list entry resulting from execution of 6, replace the leading path with the directory's new path name which is the concatenation of the target directory path with the target object name.

8. UPDATE name entry in database as follows:

a. If rename involves changing directories, then replace path in name entry with path of target parent directory.

b. Replace object in name entry with target object name.
9. Proceed to update node as described above.

For the case where only the symbolic name is changing, the event may be recorded with only one entry. The event parameter identifies the nature of the rename. Possibilities for rename include (i) rename where only the symbolic name for the file is changed (the file does not change directories), and (ii) rename where the file is moved from one directory to another. It is the second case where two events may appear. The first event identifies the parent directory of origin (the source) and the second event identifies the destination parent directory (the target). The symbolic name may change as part of this move.

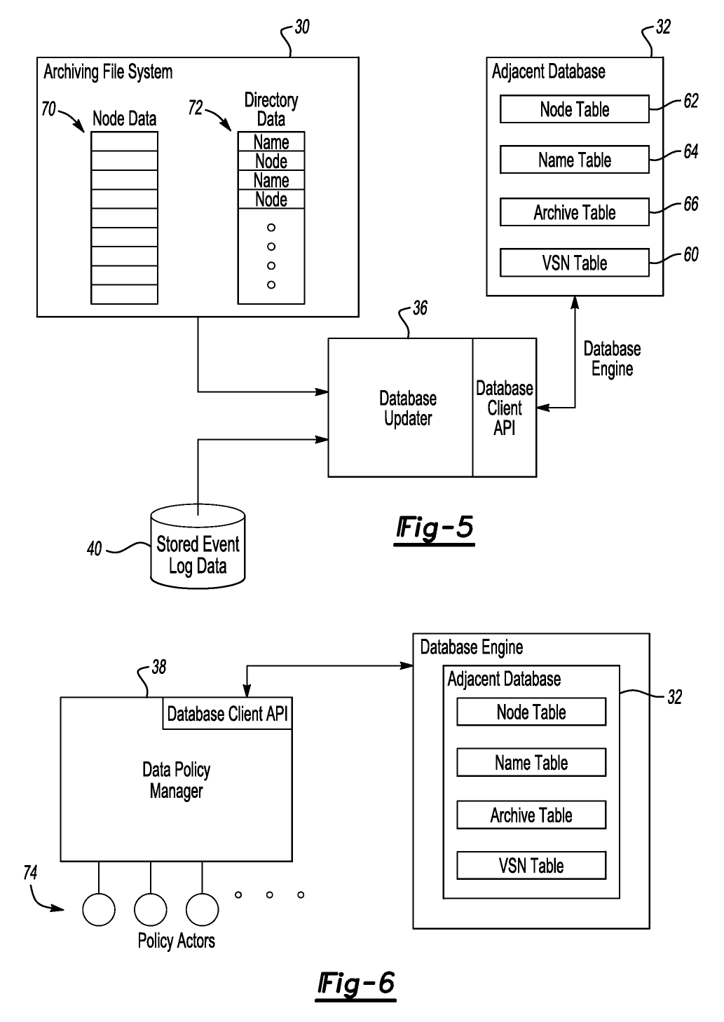

Referring now to FIG. 6, the data policy manager 38 is responsible for the governance of the data policies as they are defined for the file system 30 illustrated in FIG. 2. The policy manager 38 enforces its policies by making queries of the adjacent database 32 to determine compliance of the files represented in the archiving file system 30. To govern a policy, the data policy manager 38 generates a list of candidate files that qualify for the given policy and initiates one or more policy actors 74 to act upon the list of files. The policy actor(s) 74 at the time of processing verifies with the file system 30 that each candidate file in the list is qualified for the policy-based action.

Policies may include secondary storage disposition, data lifespan and retention enforcement, and secondary storage recycling. Informative queries of the database 32 may also be made including complete temporal file history, secondary storage utilization, secondary storage contents, and the construction of inventories for specific units of secondary storage. To respond to these queries, the database 32 need not be fully synchronized with the file system 30 illustrated in FIG. 2. The file system 30 may retain authority during execution of the policies.

As apparent to those of ordinary skill, the algorithms, etc. disclosed herein may be deliverable to a processing device in many forms including, but not limited to, (i) information permanently stored on non-writable storage media such as ROM devices and (ii) information alterably stored on writeable storage media such as floppy disks, magnetic tapes, CDs, RAM devices, and other magnetic and optical media. The algorithms, etc. may also be implemented in a software executable object. Alternatively, the algorithms, etc. may be embodied in whole or in part using suitable hardware components, such as Application Specific Integrated Circuits (ASICs), state machines, controllers or other hardware components or devices, or a combination of hardware, software and firmware components.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A data policy management system comprising:
one or more computers configured to execute
an archiving file system,
a database system,
at least one asynchronous update process, wherein the archiving file system is configured to inform the at least one asynchronous update process of nodes that have been updated, and wherein the at least one asynchronous update process is configured to (i) acquire current information contained within the nodes that has been updated and (ii) update data contained within the database system to reflect the acquired information, and
at least one data policy manager process configured to (i) query the database system and (ii) enforce a set of data policies upon the archiving file system based on results of the query.

2. The data policy management system of claim 1 wherein the one or more computers are further configured to execute at least one event logging process configured to (i) acquire time ordered node state change events within the archiving file system and (ii) store the node state change events.

3. The data policy management system of claim 2 wherein the at least one asynchronous update process is further configured to read the stored node state change events, wherein the stored node state change events trigger the at least one asynchronous update process to acquire the current information contained within the nodes that has been updated, and update the data contained within the database system to reflect the acquired information.

4. The data policy management system of claim 3 wherein the at least one asynchronous update process is further configured to serially read the stored node state change events.

5. The data policy management system of claim 1 wherein the at least one asynchronous update process serially updates the data contained within the database system to reflect the acquired information.

6. The data policy management system of claim 1 wherein the asynchronous update process is further configured to update the data contained within the database system to reflect the acquired information if the acquired information is inconsistent with the data contained within the database system.

7. The data policy management system of claim 1 wherein enforcing the set of data policies upon the archiving file system based on results of the query includes generating a candidate list of files from the database system upon which the set of data policies is to be enforced.

8. The data policy management system of claim 7 wherein the at least one data policy manager process is further configured to initiate at least one policy actor process, and wherein the at least one policy actor process is configured (i) to accept the candidate list and (ii) to acquire the current information contained within the node of each of the files of the candidate list.

9. The data policy management system of claim 8 wherein the at least one policy actor process is further configured to determine if each of the files of the candidate list is valid for the set of data policies.

10. The data policy management system of claim 1 wherein the at least one data policy manager process is further configured to identify, as a result of the query, a temporal instance of data associated with the nodes that have been updated as one of (i) active, in which the temporal instance of data is available through the archiving file system, (ii) dormant, in which the temporal instance of data has been replaced and is restorable, and (iii) expired, in which the temporal instance of data has been replaced and is no longer restorable per the set of data policies.

11. The data policy manager system of claim 1 wherein the data contained within the database system and the current information contained within the nodes are inconsistent.

12. A method for managing data comprising:
identifying nodes of an archiving file system executing on one or more computers that have been updated;
acquiring time ordered node state change events within the archiving file system;
storing the node state change events;
reading the stored node state change events;
acquiring current information contained within the nodes that has been updated;
updating data contained within a database system executing on the one or more computers to reflect the acquired information;
querying the database system; and
enforcing data policies upon the archiving file system based on the results of the query.

13. The method of claim 12 wherein the stored node state change events are read serially.

14. The method of claim 12 wherein the data contained within the database system is updated to reflect the acquired information serially.

15. The method of claim 12 wherein the data contained within the database system is updated to reflect the acquired information if the acquired information is inconsistent with the data contained within the database system.

16. The method of claim 12 wherein enforcing data policies upon the archiving file system based on the results of the query includes generating a candidate list of files from the database system upon which the set of data policies is to be enforced.

17. The method of claim 16 further comprising initiating a policy actor process configured (i) to accept the candidate list, (ii) to acquire the current information contained within the node of each of the files of the candidate list, and (iii) to determine if each of the files of the candidate list is valid for the set of data policies.

18. A computer storage medium having information stored thereon for directing one or more computers to (i) identify nodes of an archiving file system that have been updated, (ii) acquire time ordered node state change events within the archiving file system, (iii) store the node state change events, (iv) read the stored node state change events, (v) acquire current information contained within the nodes that has been updated, (vi) update data contained within a database system to reflect the acquired information, (vii) query the database system, and (viii) enforce data policies upon the archiving file system based on the results of the query.
